(19) United States
(12) Patent Application Publication
(10) Pub. No.: US 2019/0129576 A1
(43) Pub. Date: May 2, 2019

(54) PROCESSING OF CORRESPONDING MENU ITEMS IN RESPONSE TO RECEIVING SELECTION OF AN ITEM FROM THE RESPECTIVE MENU

(71) Applicant: Lenovo Enterprise Solutions (Singapore) Pte. Ltd., Singapore (SG)

(72) Inventors: Matthew R. Alcorn, Durham, NC (US); James G. McLean, Raleigh, NC (US)

(21) Appl. No.: 15/796,601

(22) Filed: Oct. 27, 2017

(51) Int. Cl. G06F 3/0482

(52) U.S. Cl. CPC G06F 3/0482; G06F 3/0488

(57) ABSTRACT

A method according to one embodiment includes outputting a first menu, receiving selection of an item from the first menu, and outputting the selected item from the first menu along with a second menu having items corresponding to the selected item of the first menu. Unselected items from each menu are deemphasized in response to receiving the selection of the item from the respective menu.

### FIELD OF THE INVENTION

The present invention relates to nested menus and more particularly, this invention relates to providing easier navigation of nested menus, e.g., on a mobile device.

### BACKGROUND

Users of computer devices often use such devices to perform tasks such as view files, read emails and articles, and output data and information to other devices. For example, users of computer devices commonly use their personal devices to send information, e.g., pictures, video files, web browser domains, etc., to computer devices of family and/or associates. Users also use the computer devices to perform tasks, such as storing, deleting, and/or bookmarking data.

During such outputting and/or tasks, users typically must navigate through a plurality of different applications and extensive menus. For example, particularly on conventional mobile devices, there currently exists the paradigm that a user can select an action or item on a screen, and in response to the selection, receive a popup, sheet, or dialog with extra actions that the user can select to occur. The selected action or item disappears when the new item is presented. In another example, a user wishing to send a simple picture file to a friend must typically navigate through a plurality of different device applications in the time between the user selecting the particular picture file that is to be sent and the user selecting the destination user address. These dialogs and narrations tend to be inconsistent between applications and devices, and moreover can break the user's flow and context.

### SUMMARY

A method according to one embodiment includes outputting a first menu, receiving selection of an item from the first menu, and outputting the selected item from the first menu along with a second menu having items corresponding to the selected item of the first menu. Unselected items from each menu are deemphasized in response to receiving the selection of the item from the respective menu.

A computer program product, according to one embodiment, includes a computer readable storage medium having stored thereon computer readable program instructions configured to cause a processor of a computer system to perform the foregoing method.

A system according to one embodiment includes a display having a sensory input system for receiving selections, and a processor. The system also includes logic integrated with and/or executable by the processor, the logic being configured to cause the processor to perform the foregoing method.

### BRIEF DESCRIPTION OF THE DRAWINGS

FIG. 1 illustrates a network architecture, in accordance with one embodiment.

FIG. 2 illustrates an exemplary system, in accordance with one embodiment.

FIG. 3 illustrates a flowchart of a method, in accordance with one embodiment.

FIG. 4A illustrates a computer device display, in accordance with one embodiment.

FIG. 4B illustrates the computer device display of FIG. 4A, in accordance with one embodiment.

FIG. 4C illustrates the computer device display of FIGS. 4A-4B, in accordance with one embodiment.

FIG. 4D illustrates the computer device display of FIGS. 4A-4C, in accordance with one embodiment.

FIG. 5A illustrates a computer device display, in accordance with one embodiment.

FIG. 5B illustrates the computer device display of FIG. 5A, in accordance with one embodiment.

FIG. 5C illustrates the computer device display of FIGS. 5A-5B, in accordance with one embodiment.

FIG. 5D illustrates the computer device display of FIGS. 5A-5C, in accordance with one embodiment.

FIG. 6A illustrates a computer device display, in accordance with one embodiment.

FIG. 6B illustrates the computer device display of FIG. 6A, in accordance with one embodiment.

FIG. 6C illustrates the computer device display of FIGS. 6A-6B, in accordance with one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

The following description discloses several preferred embodiments that present nested menus for simpler user navigation.

In one general embodiment, a method includes outputting a first menu, receiving selection of an item from the first menu, and outputting the selected item from the first menu along with a second menu having items corresponding to the selected item of the first menu. Unselected items from each menu are deemphasized in response to receiving the selection of the item from the respective menu.

In another general embodiment, a computer program product includes a computer readable storage medium having stored thereon computer readable program instructions configured to cause a processor of a computer system to perform the foregoing method.

In yet another general embodiment, a system includes a display having a sensory input system for receiving selections, and a processor. The system also includes logic integrated with and/or executable by the processor, the logic being configured to cause the processor to perform the foregoing method.

The description herein is presented to enable any person skilled in the art to make and use the invention and is provided in the context of particular applications of the invention and their requirements. Various modifications to the disclosed embodiments will be readily apparent to those skilled in the art and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

In particular, various embodiments of the invention discussed herein are implemented using the Internet as a means of communicating among a plurality of computer systems. One skilled in the art will recognize that the present invention is not limited to the use of the Internet as a communication medium and that alternative methods of the invention may accommodate the use of a private intranet, a Local Area Network (LAN), a Wide Area Network (WAN) or other means of communication. In addition, various combinations of wired, wireless (e.g., radio frequency) and optical communication links may be utilized.

The program environment in which one embodiment of the invention may be executed illustratively incorporates one or more general-purpose computers or special-purpose devices such hand-held computers. Details of such devices (e.g., processor, memory, data storage, input and output devices) are well known and are omitted for the sake of clarity.

It should also be understood that the techniques of the present invention might be implemented using a variety of technologies. For example, the methods described herein may be implemented in software running on a computer system, or implemented in hardware utilizing one or more processors and logic (hardware and/or software) for performing operations of the method, application specific integrated circuits, programmable logic devices such as Field Programmable Gate Arrays (FPGAs), and/or various combinations thereof. In one illustrative approach, methods described herein may be implemented by a series of computer-executable instructions residing on a storage medium such as a physical (e.g., non-transitory) computer-readable medium. In addition, although specific embodiments of the invention may employ object-oriented software programming concepts, the invention is not so limited and is easily adapted to employ other forms of directing the operation of a computer.

The invention can also be provided in the form of a computer program product comprising a computer readable storage or signal medium having computer code thereon, which may be executed by a computing device (e.g., a processor) and/or system. A computer readable storage medium can include any medium capable of storing computer code thereon for use by a computing device or system, including optical media such as read only and writeable CD and DVD, magnetic memory or medium (e.g., hard disk drive, tape), semiconductor memory (e.g., FLASH memory and other portable memory cards, etc.), firmware encoded in a chip, etc.

A computer readable signal medium is one that does not fit within the aforementioned storage medium class. For example, illustrative computer readable signal media communicate or otherwise transfer transitory signals within a system, between systems e.g., via a physical or virtual network, etc.

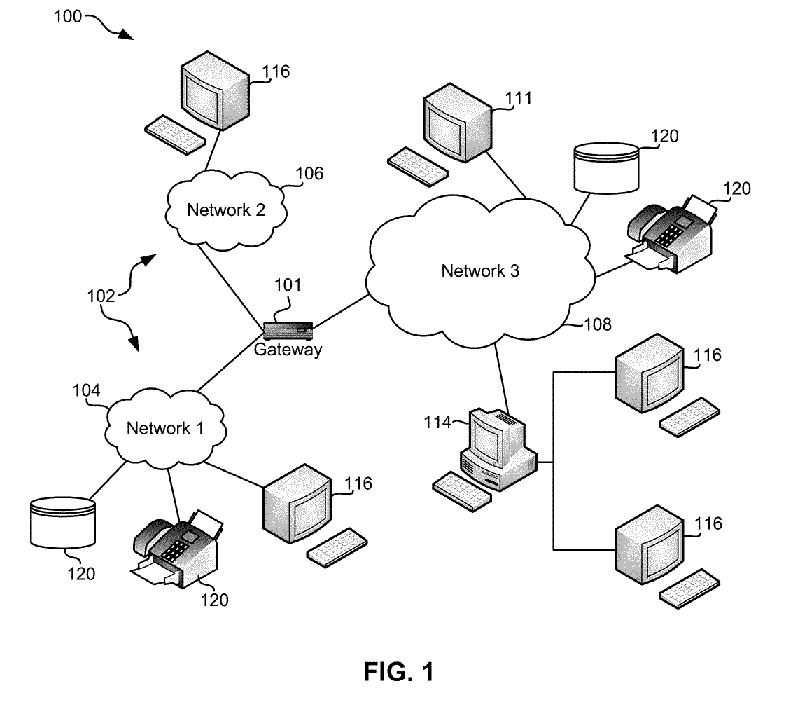

FIG. 1 illustrates an architecture 100, in accordance with one embodiment. As an option, the present architecture 100 may be implemented in conjunction with features from any other embodiment listed herein, such as those described with reference to the other FIGS. Of course, however, such architecture 100 and others presented herein may be used in various applications and/or in permutations which may or may not be specifically described in the illustrative embodiments listed herein. Further, the architecture 100 presented herein may be used in any desired environment.

As shown in FIG. 1, a plurality of remote networks 102 are provided including a first remote network 104 and a second remote network 106. A gateway 101 may be coupled between the remote networks 102 and a proximate network 108. In the context of the present network architecture 100, the networks 104, 106 may each take any form including, but not limited to a LAN, a WAN such as the Internet, public switched telephone network (PSTN), internal telephone network, etc.

In use, the gateway 101 serves as an entrance point from the remote networks 102 to the proximate network 108. As such, the gateway 101 may function as a router, which is capable of directing a given packet of data that arrives at the gateway 101, and a switch, which furnishes the actual path in and out of the gateway 101 for a given packet.

Further included is at least one data server 114 coupled to the proximate network 108, and which is accessible from the remote networks 102 via the gateway 101. It should be noted that the data server(s) 114 may include any type of computing device/groupware. Coupled to each data server 114 is a plurality of user devices 116. Such user devices 116 may include a desktop computer, laptop computer, hand-held computer, printer or any other type of logic. It should be noted that a user device 111 may also be directly coupled to any of the networks, in one embodiment.

A peripheral 120 or series of peripherals 120, e.g. facsimile machines, printers, networked storage units, etc., may be coupled to one or more of the networks 104, 106, 108. It should be noted that databases, servers, and/or additional components may be utilized with, or integrated into, any type of network element coupled to the networks 104, 106, 108. In the context of the present description, a network element may refer to any component of a network.

According to some approaches, methods and systems described herein may be implemented with and/or on virtual systems and/or systems which emulate one or more other systems, such as a UNIX system which emulates a MAC OS environment, a UNIX system which virtually hosts a MICROSOFT WINDOWS environment, a MICROSOFT WINDOWS system which emulates a MAC OS environment, etc. This virtualization and/or emulation may be enhanced through the use of VMWARE software, in some embodiments.

In more approaches, one or more networks 104, 106, 108, may represent a cluster of systems commonly referred to as a “cloud.” In cloud computing, shared resources, such as processing power, peripherals, software, data processing and/or storage, servers, etc., are provided to any system in the cloud, preferably in an on-demand relationship, thereby allowing access and distribution of services across many computing systems. Cloud computing typically involves an Internet or other high-speed connection (e.g., 4G LTE, fiber optic, etc.) between the systems operating in the cloud, but other techniques of connecting the systems may also be used.

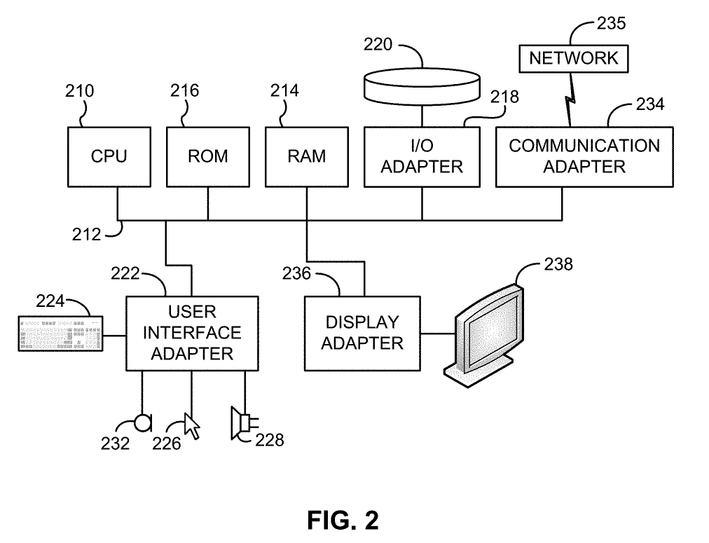

FIG. 2 shows a representative hardware environment associated with a user device 116 and/or server 114 of FIG. 1, in accordance with one embodiment. Such figure illustrates a typical hardware configuration of a workstation having a central processing unit 210, such as a microprocessor, and a number of other units interconnected via a system bus 212.

The workstation shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen and a digital camera (not shown) to the bus 212, communication adapter 234 for connecting the workstation to a communication network 235 (e.g., a data processing network) and a display adapter 236 for connecting the bus 212 to a display device 238.

The workstation may have resident thereon an operating system such as the Microsoft WINDOWS Operating System (OS), a MAC OS, a UNIX OS, etc. It will be appreciated that a preferred embodiment may also be implemented on platforms and operating systems other than those mentioned. A preferred embodiment may be written using JAVA, XML, C, and/or C++ language, or other programming languages, along with an object oriented programming methodology. Object oriented programming (OOP), which has become increasingly used to develop complex applications, may be used.

Moreover, a system according to various embodiments may include a processor and logic integrated with and/or executable by the processor, the logic being configured to perform one or more of the process steps recited herein. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Conventional computer devices often include complex architectures. For example, computer devices may include a plurality of different applications, where commonly more than one of such applications is used to perform a single desired task. In a more specific example, computer device users that wish to share or send a web article that they have come across, conventionally are narrated and/or self-narrate through more than one application to send the web article to another computer device. This natation may include transitioning from a web application, to a messaging application, and moreover potentially to a contact list of the messaging application and/or another contact application, to merely facilitate the sending of the web article to another computer device.

Embodiments described herein include implementing a plurality of corresponding nested menus in a single computer device application for providing easier navigation of nested menus.

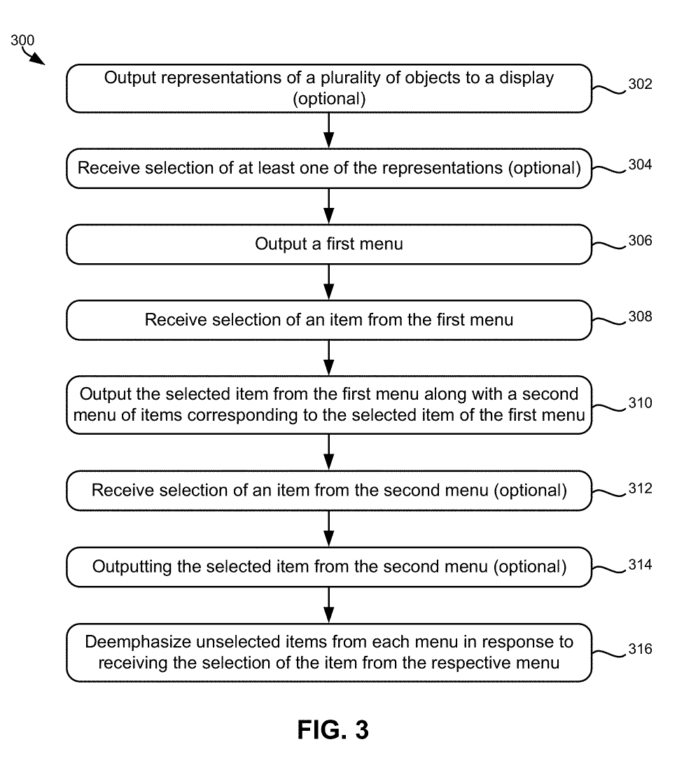

FIG. 3 depicts a method 300 for presenting a nested menu in accordance with one embodiment. The method 300 may be performed in accordance with the present invention in any of the environments depicted in FIGS. 1-2, among others, in various embodiments. Of course, more or less operations than those specifically described in FIG. 3 may be included in method 300, as would be understood by one of skill in the art upon reading the present descriptions.

Each of the steps of the method 300 may be performed by any suitable component of the operating environment. For example, in various embodiments, the method 300 may be partially or entirely performed by a controller, a processor, etc., or some other device having one or more processors therein. The processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a CPU, an application specific integrated circuit (ASIC), a field programmable gate array (FPGA), etc., combinations thereof, or any other suitable computing device known in the art.

Moreover, the following method and/or other embodiments described herein may be performed on and/or by any type of computer device, which may be a portion of a broader network environment. For example, referring again to FIG. 2, a computer device display on which method 300 may be performed may include the display device 238, which is a portion of the system of FIG. 2. Moreover, according to another example, a computer device display on which method 300 may be performed may include one or more user devices 116, which are a portion of the architecture 100 of FIG. 1.

It should be noted that although computer devices described herein may include any type of computer device, various embodiments described herein may preferably include touchscreen mobile computer devices, e.g., a touchscreen cellular phone, a touchscreen mobile tablet, a touchscreen laptop, etc.

Referring now to FIG. 3, optional operation 302 of method 300 includes outputting representations of a plurality of objects to a display. The representations may include any type of representation, in any combination, depending on the embodiment. For example, the representations may include one or more of textual identifiers, e.g., describing an object; filenames, such as filenames of stored data; icons, e.g., a graphical pointer to a stored object, application; etc.

The plurality of objects may include any type of objects, in any combination, depending on the embodiment. For example, the objects may include one or more of images, e.g., image files; textual objects such as names, key-codes, web addresses, etc.; audio files; emails; etc.

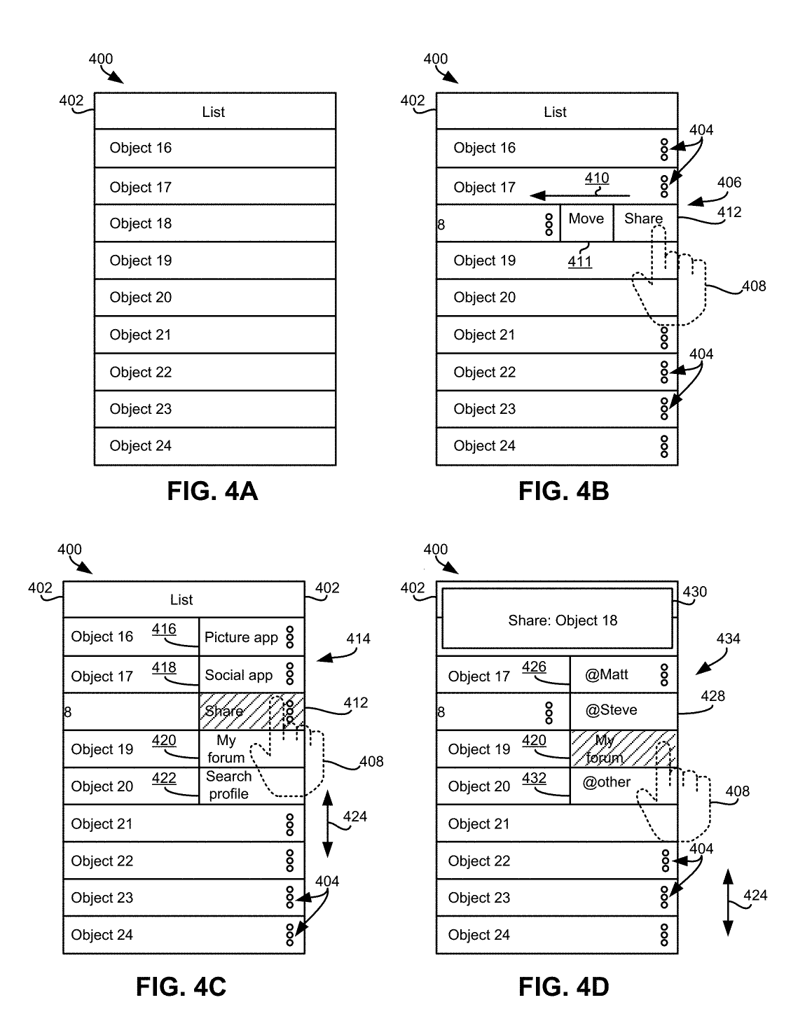

The representations may be output to any type of display. Note that illustrative computer device displays are described elsewhere herein, e.g., see FIGS. 4A-6C and related discussion. According to preferred approaches, the display includes a touchscreen display. According to one approach, the display may include a resistive touchscreen display. According to another approach, the display may include a capacitive touchscreen display. According to yet another approach, the display may include a force touch touchscreen display.

Optional operation 304 of method 300 includes receiving selection of at least one of the representations. The selection of at least one of the representations may originate from any one or more sources in any known manner. For example, the selection may be received from a sensory input system such as a touchscreen system, e.g., where the received selection corresponds to a user having touched a display of the touchscreen system. According to other approaches, the selection may be received from a touch key, e.g., of a physical phone keyboard, button, scroll wheel, etc. According to yet further approaches, the selection may be received from another sensory input system, e.g., a microphone, a camera, a touchpad, etc.

According to one approach, a sensory input system may include “hover-over” selection capabilities, where a selection may be made in response to a detection of some external object, e.g., a user finger, a stylus pen, a pointer device, etc., being held over a portion of a computer display device. Such an approach may also be known as 3-D push-through selection.

Operation 306 of method 300 includes outputting a first menu. The first menu may be output in response to any input, request, operation, etc. In the present example, the first menu is output in response to receiving the selection of at least one of the representations. Operation 308 includes receiving selection of an item from the first menu. The selection in operation 308 and other operations may be received in any manner, e.g., as in operation 304.

The first menu may include any one or more items. According to various approaches, one or more items in the first menu may correspond to an action that can be performed by the computer device on the one or more previously-selected representation(s). Illustrative actions include sharing the object; moving the object to another location, folder, etc.; displaying the object; utilizing a particular application to perform further actions; etc. For example, a selection of a particular representation may be received from a user who wishes to share the object corresponding to the representation with a friend or post on a website. In such an approach, a first menu that corresponds to the selected representation may be output to the display, and may include a “share” item and/or a “post” item, for user selection.

According to various approaches, one or more items of the first menu may correspond to a maintenance action that is to be performed on one or more objects of the selected representation(s). According to one approach, a maintenance action may include saving, copying, and/or storing one or more objects of the selected representation(s). According to another approach, a maintenance action may include deleting one or more objects of the selected representation(s). Various similar examples of such approaches will be described elsewhere herein, e.g., see FIGS. 4A-6C.

In response to receiving the selection of the item from the first menu, a subsequent output may be output to further define the selected item from the first menu, e.g., see operation 310. Operation 310 of method 300 includes outputting the selected item from the first menu along with a second menu having items corresponding to the selected item of the first menu such that the selected item of the first menu is displayed concurrently with the second menu.

For example, according to one approach, where the selected item of the first menu corresponds to sharing objects of the selected representation, a second menu may be output to the display, where items of the second menu correspond to destinations to which objects of the selected representation may be shared. In another approach, the second menu may provide further navigation options and/or action for selection, upon which a third menu may be output, and so on.

Outputting both the selected item from the first menu along with a second menu having items corresponding to the selected item of the first menu simultaneously on the display helps maintain the context and flow of previous selections for a user. For example, otherwise not outputting the selected item from the first menu along with a second menu having items corresponding to the selected item of the first menu might break a user's selection context and flow were the user to forget what previous selections resulted in the outputting of the currently displayed menus/items on a computer device display.

Outputting the selected item from the first menu along with a second menu having items corresponding to the selected item of the first menu may moreover enable using a relatively smaller portion of a computer device display, e.g., relatively smaller than otherwise displaying multiple menus with one or more unselected items of preceding menus.

It should be noted that outputting both a selected item from a particular menu, e.g., a first menu, along with an additional menu, e.g., a second menu, of items corresponding to the selected item of the particular menu is preferably enabled by using nested menus, where items of each subsequent menu correspond to, expand on, provide options for, etc. the selected item of the previous menu.

Optional operation 312 of method 300 includes receiving selection of an item from the second menu, e.g., via any input method, such as those described with reference to operation 304.

Optional operation 314 of method 300 includes outputting the selected item from the second menu.

In one approach, the received selection of an item from the second menu may correspond to a destination to which an object of the one or more previously-selected representations is to be sent. The selected item from the second menu may correspond to any destination. For example, according to one approach, a destination to which the received selection of an item from the second menu may correspond includes a computer device. According to another approach, a destination to which the received selection of an item from the second menu may correspond includes a contact address, e.g., an email address, a forum address, a phone number, a social networking identifier (e.g., username), etc.

In another approach, the received selection of an item from the second menu may correspond to an action that is to be performed on an object of the one or more previously received selected representations. For example, according to one approach, an action to which an item from the second menu may correspond includes outputting objects of the selected representation. According to another approach, an action to which an item from the second menu may correspond includes deleting objects of the selected representation. According to yet another approach, an action to which an item from the second menu may correspond includes moving objects of the selected representation. According to yet another approach, an action to which an item from the second menu may correspond includes saving objects of the selected representation.

According to yet another approach the selected item from the second menu may be output to the display along with additional information. For example, the selected item from the second menu may be output to the display with an additional menu, e.g., a third menu, in response to receiving selection of the item from the second menu. Note that illustrations and approaches described herein may include any number of nested menus, where each successive menu may be output in response to receiving a selection of an item from the previous menu. For example, as will be illustrated elsewhere herein (e.g., see FIG. 4D), a third menu with a plurality of items may be output in response to receiving selection of the item from the second menu.

Operation 316 of method 300 includes deemphasizing unselected items from each menu in response to receiving the selection of the item from the respective menu. Deemphasizing unselected items may include any type of visual deemphasizing. According to one approach, deemphasizing unselected items may include decreasing the displayed size of the unselected items. According to another approach, deemphasizing unselected items may include eliminating the unselected items from the display. According to another approach, deemphasizing unselected items may include changing the color and/or contour of the unselected items on the display, e.g., darkening the coloring and/or contour of unselected items, brightening the coloring and/or contour of unselected items, etc. According to yet another approach, deemphasizing unselected items may include blurring the unselected items and/or the contour of the unselected items on the display. According to yet another approach, deemphasizing unselected items may include patterning the contour of unselected items on the display.

A reduction of graphics processing may result from the deemphasizing of unselected items from each menu in response to receiving the selection of the item from the respective menu. The deemphasizing of unselected items may moreover allow the maintaining of context for users while navigating through selections. Such deemphasizing of non-selected items may furthermore prevent display overcrowding.

As noted above, selection of a representation and/or a menu item may include detection of sensory inputs. According to one approach, the sensory input may include physical contact, e.g., such as a user touching a touchscreen display of a computer device. According to another approach, the sensory input may include audible commands. In response to receiving such sensory input, one or more actions may be performed. For example, in response to receiving the audible sensory input “delete object” when one of the selectable menu items is “delete object,” the object may be deleted.

In some approaches, a particular input type such a user gesture, e.g., a swipe gesture, a flick gesture, a squiggle gesture, a patterned tapping of the display, etc., on a touchscreen display of a computer device may be associated with a predetermined menu and/or action.

According to one approach, a first action may be performed upon receiving a selection corresponding to a first type of sensory input of at least one of the menu items.

According to another approach, a second action may additionally and/or alternatively be performed upon receiving a selection corresponding to a second type of sensory input of the at least one of the menu items.

For example, the items output in a particular menu may be dependent upon the particular type of input received. For example, items corresponding to similar actions may be grouped for outputting in response to receiving a particular selection and/or sensory input. In a more specific example, one or more items that correspond to a first “positive” action, e.g., file, reply, bookmark, etc., may be grouped for output in response to receiving one type of sensory input, e.g., a swipe in one direction, while one or more items that correspond to a second “negative” action, e.g., delete, block, forget, etc., may be grouped for output in response to receiving another type of sensory input, e.g., a swipe in a second direction different than the first direction. Preferably, the first and second directions are about opposite, whereby opposite sensory inputs may correspond to grouped actions of about the opposite type. For example, a received sensory input of a user swipe gesture in a right to left direction on a touchscreen display of a computer device may correspond to actions that may be considered positive, while a received sensory input of a user swipe gesture in a left to right direction on a touchscreen display of the computer device may correspond to actions that may be considered negative. Having about opposite sensory inputs correspond to about opposite grouped actions may assist a user to quickly and easily navigate menus while retaining context while doing so. A further example of grouping items that correspond to similar actions for outputting in response to receiving a particular selection and/or sensory input will be described elsewhere herein, e.g., see swiping of a representation object 18 in a first direction 410 in FIG. 4B.

While any action can be associated with a particular input type, illustrative actions include deleting and/or saving the object associated with a received gesture on a touchscreen display, emailing the object associated with a received gesture on a touchscreen display, selecting the object associated with a received gesture on a touchscreen display, etc.

According to various approaches, feedback may be output in response to receiving a selection of one or more representations and/or items of a menu. According to various approaches, such feedback may include visual feedback, e.g., light pulsing on the display, dimming of unselected representations and/or items on the display, changing the color of selected representations and/or items on the display, etc. According to other approaches, feedback may include audio feedback, e.g., an audible tune, a notification ding, a series of beeps, etc. According to yet further approaches, output feedback may include haptic cues, e.g., vibration, indenting a portion of a computer device associated with the display, etc.

Outputting feedback may assist a user in quickly and easily navigating menus while retaining context while doing so. According to various approaches, such feedback may indicate that an input has been received and/or that a selection is ready to be received.

With general reference now to method 300, each of the menu output operations of method 300 are preferably implemented as a progression through nested menus (with corresponding menu items), e.g., as will described in greater detail in FIGS. 4A-6C. Outputting menu items in a nested menu format while retaining the previously-selected menu item may allow a user to navigate multiple menus on a single screen, while maintaining the user's context, and without requiring the user to navigate through a plurality of different applications and/or inconsistent menus. For example, the process may enable a user to perform a desired action on an object via simple navigation of the menus, without being redirected to a plurality of applications. Rather, the action may be performed without accessing a secondary application, or the secondary application may be invoked in response to selection of the final menu item.

Corresponding nested menus streamline computer device usage for users, and moreover prevent user confusion which might otherwise occur as a result of users navigating through a plurality of different applications and extensive menus while using a computer device. This prevents a user from being subjected to various separate application narrations, e.g., popups, sheets, dialog with extra actions that the user can select to occur, etc., which might otherwise break the user's flow and context while using the computer device.

Illustrative examples of corresponding nested menus, such as those described in method 300, are described in detail below, e.g., see FIGS. 4A-6C.

FIGS. 4A-6C depict computer device displays 400, 500, in accordance with various embodiments. As an option, the present computer device displays 400, 500 may be implemented in conjunction with features from any other embodiment listed herein, such as those described with reference to the other FIGS. Of course, however, such computer device displays 400, 500 and others presented herein may be used in various applications and/or in permutations which may or may not be specifically described in the illustrative embodiments listed herein. Further, the computer device displays 400, 500 presented herein may be used in any desired environment.

FIGS. 4A-4D include a computer device display 400. Computer device display 400 may be a portion of any type of computer device. Moreover, computer device display 400 may be any type of computer device display. According to one approach, the computer device display 400 may include touch screen functionality, e.g., see FIGS. 4B-4D. According to another approach, the computer device display 400 may additionally and/or alternatively be controllable via voice recognition/selection functionality. According to yet another approach, the computer device display 400 may additionally and/or alternatively include stylus screen functionality.

Referring now to FIG. 4A, computer device display 400 includes representations object 16-object 24 of a plurality of objects. It should be noted that although the plurality of objects are not specifically shown in FIGS. 4A-4D, each of the one or more representations object 16-object 24 may correspond to one or more objects. According to one approach, a selection of a particular representation may correspond to a selection of each of the objects corresponding to the selected representation.

According to various approaches, the computer device display 400 may optionally display an overview title 402. According to one approach, the overview title 402 may note the type of representations and/or menus displayed by the computer device display 400. For example, the overview title 402 notes that a list of representations object 16-object 24 are displayed on the computer device display 400.

According to various approaches, a selection of at least one of the representations object 16-object 24 may be received, e.g., corresponding to any of the selection types described herein.

According to one approach, a received physical tap and/or plurality of taps of at least one of the representations object 16-object 24 displayed on the computer device display 400 may correspond to a selection of at least one of the representations object 16-object 24.

According to another approach, one or more received physical swipe gestures of at least one of the representations object 16-object 24 displayed on the computer device display 400 may correspond to a selection of at least one of the representations object 16-object 24.

According to various approaches, at least portions of the representations object 16-object 24 of the plurality of objects may remain displayed during the outputting of one or more menus to the computer device display 400. According to one approach, as illustrated in FIG. 4B, in response to the representation object 18 being selected, the contour of the representation object 18 may be shifted in a first direction 410, and thereby only a portion of the representation object 18 may be output and displayed on the computer device display 400. In the current approach, displaying only a portion of the selected representation object 18 may provide room on the computer device display 400 for a first menu 406.

According to further approaches, the entire contour of the selected representation may additionally and/or alternatively be reduced in size and remain on the computer device display 400, to thereby provide room on the computer device display 400 for one or more menus.

The computer device display 400 may additionally and/or alternatively include a first menu 406. According to various approaches, the first menu 406 and/or other menus described elsewhere herein may include any number of optional items. According to one approach, one or more of the optional items of the menus may correspond to an action to perform on the object of a selected representation. For example, the first menu 406 includes an item Share 412, and an item Move 411.

According to various approaches, a received sensory input may correspond to the selection of a representation, e.g., representation object 18. For example, according to one approach, a user 408 may swipe the computer device display 400 in the first direction 410. In response to the computer device display 400 receiving the user swipe in the first direction 410, the first menu 406 is output on the computer device display 400.

According to one approach, a particular sensory input type may be detected, such as a user swipe in the first direction 410. In such an approach, items corresponding to similar actions may be grouped for outputting in response to receiving a swipe selection in the first direction 410. The grouped items may be output to the display 400 in response to receiving such a swipe selection. For example, the item Share 412 and the item Move 411 may be items corresponding to similar actions which were output to the device display 400.

In continuance of the present example, different items corresponding to other similar actions may be grouped for outputting in response to receiving a different sensory input from a user, such as a swipe selection in a second direction. Such items may be output to the display 400 in response to receiving the different sensory input. For example, in response to receiving a sensory input swipe in a direction opposite the first direction 410, a different menu including different items corresponding to other similar actions, e.g., delete, block, forget, etc., may be output to the display 400.

According to another approach, a received user sensory input may include detecting a user 408 maintaining contact with the computer device display 400 throughout a plurality of representation and/or item selections. Such an approach may desirably enable a user to navigate nested menus with a single continuous touch.

According to various approaches, one or more of the representations object 16-object 24 of computer device display 400 may include a representation graphical element 404. Graphical elements described herein may include any type of graphical icon and/or indicator. According to one approach, one or more graphical elements may include a plurality of bubbles, e.g., see graphical elements 404. According to another approach, one or more graphical elements may include one or more displayed shapes, e.g., a triangle, a square, a circle. According to yet another approach, one or more graphical elements may include a displayed pattern, e.g., a squiggle line, a dashed line, a shading of the representation and/or menu item, etc. According to yet another approach, one or more graphical elements may include descriptive and/or symbolic text, e.g., “more,” “see attached,” “ . . . ,” “a, b, c,” etc.

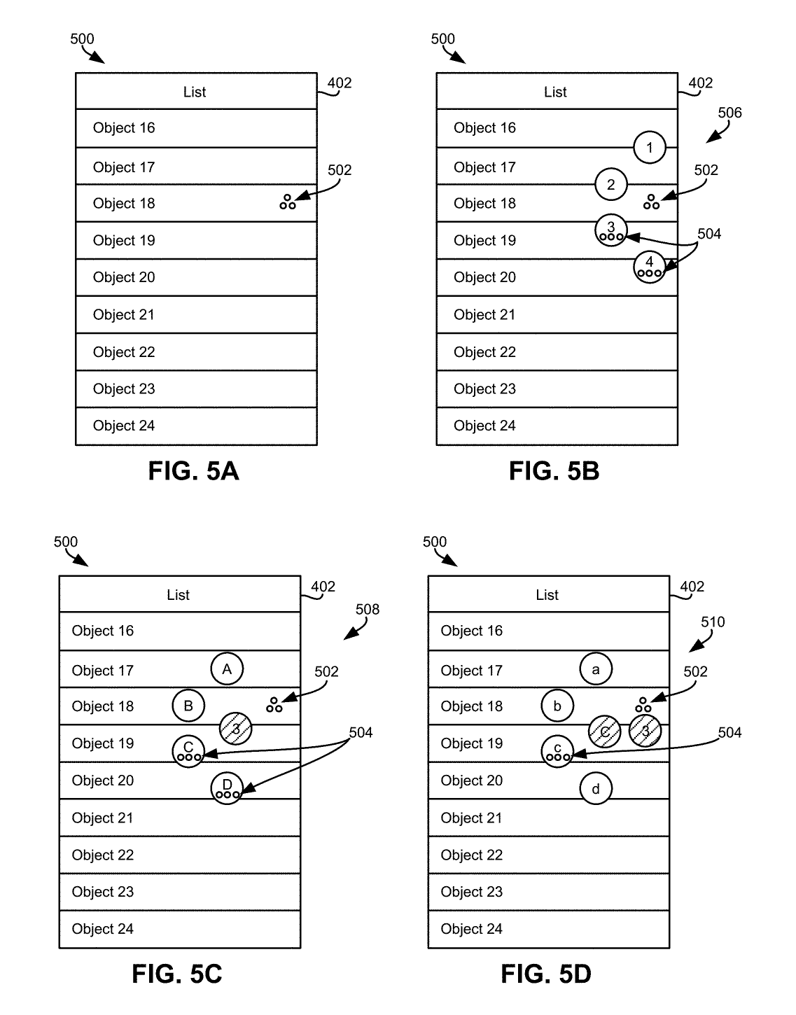

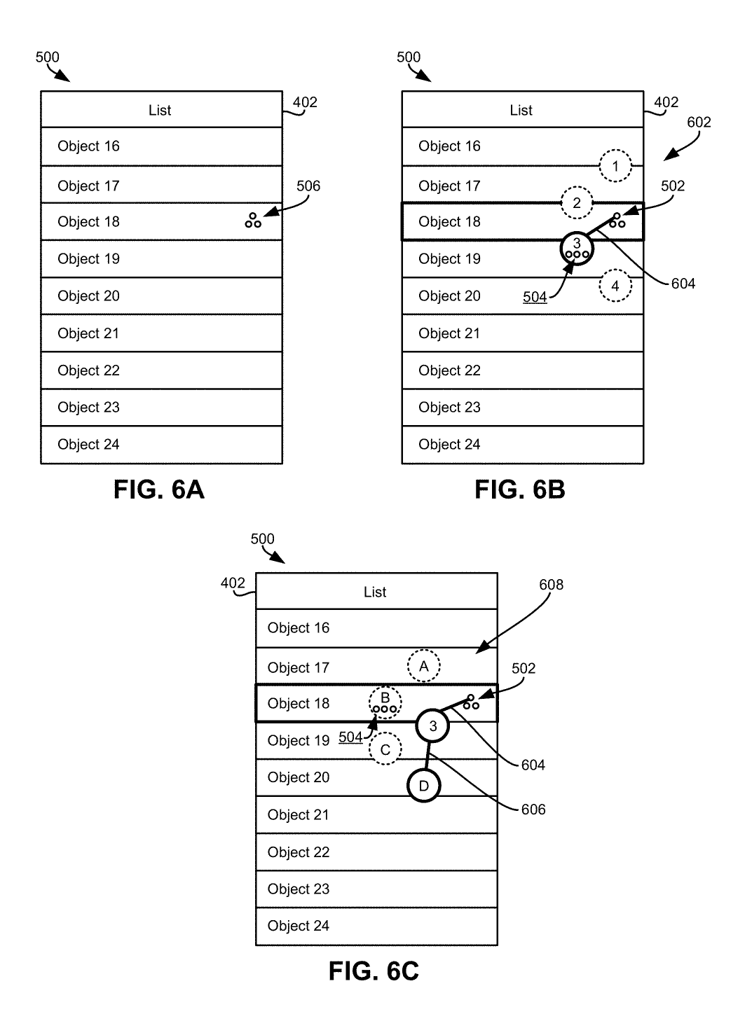

According to one approach, representation graphical elements 404 may denote that the representations object 16-object 24 include an item and/or nested menu associated therewith, e.g., such as the first menu 406. According to one approach, representation graphical elements 404 may denote that the representations object 16-object 24 include a plurality of objects. Other types of graphical elements will be described elsewhere herein, e.g., see representation graphical elements 502 of FIGS. 5A-6C and item graphical elements 504 of FIGS. 5B-5C and FIGS. 6B-6C.

Referring now to FIG. 4C, in response to receiving a selection of the item Share 412 of the first menu 406, the selected item Share 412 from the first menu 406 along with a second menu 414 of items 416, 418, 420, 422 may be output to and displayed on the computer device display 400. Note that the unselected item Move 411 of the first menu 406 is deemphasized in response to the item Share 412 from the first menu 406 being selected.

According to various approaches, any of the menus described herein may include more items than are at one time displayed on the computer device display 400. In such approaches, one or more of the un-displayed items may be output to the computer device display 400 in response to receiving a user 408 sensory input on the computer device display 400. For example, in response to receiving a user sensory input, e.g., a swipe along a first axis 424, on the computer device display 400, one or more un-displayed items and/or representations may be output to the computer device display 400. For example, the one or more un-displayed items output to the computer device display 400 may replace one or more items currently displayed on the computer device display 400, e.g., such as the items 412, 416, 418, 420, 422 being replaced by items 426, 428, 420, 432 in FIG. 4C to FIG. 4D. In another example, the menu items may scroll across the computer device display 400 in response to receiving a user sensory input, e.g., a swipe along a first axis 424, on the computer device display 400. The item from the previous menu, e.g., My forum, may remain displayed in the same position, may scroll with items in the current menu, may move to a different location on the in response to receiving a user sensory input, e.g., a swipe along a first axis 424, on the computer device display 400, etc.

It should be noted that although menu items and representations of various approaches described herein are arranged in linear list orientations, according to other approaches, menu items and/or representations may be arranged in non-linear layouts, e.g., bubble and/or wheel layouts. In such approaches, one or more un-displayed items and/or representations may be output to the computer device display 400 in response to receiving a user input on the non-linear layouts displayed on the computer device display 400. According to various approaches, such inputs may include, e.g., swiping a displayed wheel layout, tapping a displayed bubble layout, holding a finger on a displayed wheel layout for a predetermined period of time, and/or any other sensory input types described elsewhere herein.

According to various approaches, one or more items 416, 418, 420, 422 of the second menu 414 may correspond to the selected item Share 412 from the first menu 406. Specifically, in the current approach, the items 416, 418, 420, 422 of the second menu 414 correspond to various media platforms, e.g., item Picture app 416, item Social app 418, item My forum 420, and item Search profile 422, (respectively) to which the plurality of objects of the selected representation object 18 may be shared e.g., in response to previously receiving a selection of the item Share 412.

According to further approaches, one or more items 416, 418, 420, 422 of the second menu 414 may correspond to additional actions to perform on the plurality of objects of the selected representation object 18, e.g., in addition to the previously received share action of selected item Share 412.

In joint reference now to FIGS. 4C-4D, a selection has been received, e.g., from the user 408, to share the plurality of objects of the selected representation object 18 on the forum corresponding to the item My Forum 420.

According to various approaches a different and/or partial overview title 402 may be thereafter output in response to receiving a selection from one of the menus. For example, referring to FIG. 4D, the overview title 402 is partially displayed on the computer device display 400, and a second overview title 430, noting that the item Share 412 has been selected, is also displayed, e.g., in response to such titles being output to the computer device display 400.

According to various approaches, the selected item from the second menu 414 may be output along with a third menu having items corresponding to the selected item of the second menu e.g., for displaying on the computer device display 400. For example, referring now to FIG. 4D, the computer device display 400 includes the selected item My forum 420 from the second menu 414, along with a third menu 434 of items 426, 428, 432 corresponding to the selected item My forum 420 of the second menu 414. The item My forum 420 may include a trace, e.g., shading in the present illustration, corresponding to and noting the previous selection of the item My forum 420. Note that traces of selected items will be described in detail elsewhere herein, e.g., see FIGS. 6B-6C.

According to the present example, the items 426, 428, 432 of the third menu 434 may correspond to stored user contacts of a selected destination item, e.g., user contacts that correspond to the selected item My forum 420. For example, @Matt, @Steve and @other may be usernames of users that also access/receive data from the forum associated with the item My forum 420.

With continued reference to the present example, the plurality of objects of the selected representation object 18 may be shared with one or more contacts corresponding to items 426, 428, 432 of the third menu 434 upon a selection of such items being received. It should be noted that in response to receiving a selection of the item 420 of the third menu 434, the items 426, 428, 420, 432 of the third menu 434 may again be output for displaying on the computer device display 400.

According to another approach, in response to receiving a selection of an item 426, 428, 432 from the third menu 434, the selected item from the third menu 434 may be output, e.g., for displaying on the computer device display 400, along with a fourth menu (not shown) having items corresponding to the selected item of the third menu 434.

It should be noted that although three menus are illustrated as being output to and displayed by the computer device display 400 in FIGS. 4A-4D, according to other approaches, an action may be performed on and/or using the plurality of objects of any selected representation in response to receiving any selection. For example, according to one approach, a plurality of objects of a selected representation may be output to the forum associated with the item My forum 420, solely in response to receiving a selection of the item My forum 420.

Referring now to FIGS. 5A-6C, which depict additional examples, the computer device display 500 may be a portion of any type of computer device and/or network environment. Moreover, computer device display 500 may be any type of computer device display, e.g., such as those described elsewhere herein.

Referring now to FIG. 5A, the computer device display 500 illustrates representations object 16-object 24 of a plurality of objects.

The computer device display 500 may display representation graphical elements 502, which may be similar to the representation graphical element 404 of FIGS. 4B-4D.

Referring now to FIG. 5B, a selection has been received of representation object 18. According to various approaches, in response to receiving a selection of the representation object 18, a first menu 506 may be output to the computer device display 500. The first menu 506 may include a plurality of items, e.g., items 1-4.

According to various approaches, menu items having a nested menu thereunder may have a graphical element denoting said nested menu. For example, items 3-4 of the first menu 506 include item graphical elements 504, which may indicate that items 3-4 each include a nested menu thereunder.

Referring now to FIG. 5C, a selection has been received of item 3 of the first menu 506. In response to receiving a selection of item 3 of the first menu 506, a second menu 508 (the nested menu of item 3 of the first menu 506) may be output to the computer device display 500. The second menu 508 may include one or more items, e.g., items A-D.

Referring now to FIG. 5D, a selection has been received of item C of the second menu 508. In response to receiving a selection of item C of the second menu 508, a third menu 510 (the nested menu of item C of the second menu 508) may be output to the computer device display 500. The third menu 510 may include one or more items, e.g., items a-d.

According to various approaches, each of the selected items from each of the menus in a sequence may remain displayed after each respective received selection and/or outputting operation. Moreover, as described elsewhere herein, unselected items may be deemphasized. For example, as illustrated in FIG. 5C, item 3 of the first menu 506 remains displayed on the computer device display 500 after the second menu 508 is output to the computer device display 500. Furthermore, the unselected items of the first menu 506, i.e., items 1, 2, 4, are eliminated from the computer device display 500. As described elsewhere herein, the deemphasizing of unselected items may include any type of visual deemphasizing, and should not be considered limited to only eliminating the unselected items from the computer device display 500. Item 3 and item C may include a trace, e.g., shading in the present illustration, corresponding to and noting the previous selections of item 3 and item C. Note that traces of selected items will be described in detail elsewhere herein, e.g., see FIGS. 6B-6C.

According to various approaches, any previous item displayed on the computer device display 500 may thereafter be re-emphasized on the computer device display 500 in response to receiving a predefined input. For example, one or more previously-unselected items may be re-emphasized on the computer device display 500, e.g., in response to receiving a selection of an item of a previous menu and/or receiving a selection of a representation. Re-emphasizing one or more items on the computer device display 500 may allow a “backing out” of a previous series of selections and prevent a user from having to re-traverse a series of selections from a starting display of representations. Re-emphasizing one or more items on the computer device display 500 may moreover prevent a user from having to perform an unnecessary number of selections to re-display one or more previously displayed items on the computer device display 500.

According to one example, assume that a third menu has been output in response to receiving selections of a representation and items of both a first and second menu. Moreover, assume that each of the selected items of the previous menus remain displayed after each respective outputting operation, e.g., remain displayed in a de-emphasized manner but not entirely eliminated from the display. Specifically, in such an example, the previously selected items from the first and second menus are output with the third menu of items. In response to receiving selection of the previously-selected item of the first menu, the unselected items of the second menu may be re-emphasized, as well as the selected menu item of the second menu, resulting in reversion to the menu items shown in FIG. 5C. In the present example, enabling the user to select the previously-selected item of the first menu while the third menu is currently displayed prevents the user from having to re-traverse to the second menu starting from a base representation selection.

To graphically illustrate the foregoing concept, referring to FIGS. 5A-5D, assume that a user has unintentionally selected item C of the second menu 508, where the user otherwise intended to select item D of the second menu 508. Based on the selection of C, items a-d of the third menu 510 are presently output to the computer device display 500, as illustrated in FIG. 5D. In response to receiving a selection thereafter of item 3 on the display of FIG. 5D, the unselected items of the second menu 508, e.g., items A, B, D, may be re-emphasized. According to one approach, such a re-emphasizing may include re-displaying items A, B, D. According to another approach, such a re-emphasizing may include re-displaying the entire second menu 508, e.g., as shown in FIG. 5C. In response to item D of the second menu 508 being re-emphasized, item D of the second menu 508 would thereafter be again available for selection.

According to another example, referring to FIGS. 5A-5C, assume that a user has unintentionally selected item 3 of the first menu 506, where the user otherwise intended to select item 4 of the first menu 506. Based on the selection of item 3, items A-D of the second menu 508 are presently output to the computer device display 500, as illustrated in FIG. 5C. In response to receiving a selection thereafter of representation object 18 or the graphical element 502, the unselected items of the first menu 506, e.g., items 1, 2, 4, may be re-emphasized. In response to item 4 of the first menu 506 being re-emphasized, item 4 of the first menu 506 would thereafter be again available for selection.

Referring now to FIGS. 6A-6C, an illustrative nested menu traversal of the computer device display 500 will now be described according to further approaches.

Referring now to FIG. 6A, the computer device display 500 illustrates representations object 16-object 24 of a plurality of objects.

Referring now to FIG. 6B, a first menu 602 of items 1-4 may be output to the computer device display 500, in response to receiving a selection of representation object 18. Moreover, in FIG. 6C, a second menu 608 of items A-D may be output to the computer device display 500, in response to receiving a selection of item 3 of the first menu 602.

According to various approaches, a trace of selected representations and/or items may be output to the computer device display 500. The trace of selected representations and/or items may include any visual indication, e.g., graphical trails, breadcrumbs, illuminations, etc., illustrated on the computer device display 500 corresponding to the selection of such representations and/or items. The trace of selected representations and/or items may highlight selection routing as an aid to maintaining context for users while the user navigates nested menus.

According to one approach the trace of selected representations and/or items may include patterning the contour of the selected representation and/or item. For example, referring to FIGS. 6B-6C, a contour of the selected representation object 18, a contour of the selected item 3 of the first menu 602, and a contour of the selected item D of the second menu 608 are each thickened. As also shown in FIGS. 6B-6C, the contours of the deemphasized items are depicted in dashed lines.

According to another approach, the trace of selected representations and/or items may additionally and/or alternatively include one or more highlighting contrasts, e.g., as compared to a non-highlighted contrast of unselected representations and/or items.

According to another approach, the trace of selected representations and/or items may additionally and/or alternatively include a color differentiation to any unselected representations and/or items.

According to yet another approach, the trace of selected representations and/or items may additionally and/or alternatively include one or more size contrasts, e.g., where the display size of a selected representation is different than the display size of unselected representations and/or the display sizes of selected items are different than the display sizes of unselected items.

According to various approaches, the trace may include an indicator indicative of an order in which selection of the representations and/or items has been received.

According to one approach, the indicator of a trace may include connecting consecutively selected representations and/or items with a displayed string. For example, referring to FIGS. 6B-6C, a first output string segment 604 connects representation graphical element 502 of the selected representation object 18 and the next selected item 3 of the first menu 602. Furthermore, a second output string segment 606 connects the selected item 3 of the first menu 602 and the next selected item D of the second menu 608.

According to another approach, the indicator of a trace may include connecting consecutively selected representations and/or items with one or more displayed arrows, e.g., where the one or more arrows denote the progression of selection of the representations and/or items.

According to another approach, the indicator of a trace may include displaying the contour of consecutively selected representations and/or items to touch one another, e.g., a bubbling sequence, beginning with the first selected representation and/or item.

According to yet another approach, the indicator of a trace may include bolding the contour and/or contents of consecutively selected representations and/or items, e.g., where the contour and/or contents of unselected representations and/or items remain unbolded.

Implementations of the output traces and/or other indicators described herein develop and thereafter utilize user muscle memory, which may be used to more accurately and quickly perform familiar or repetitive actions when using a computer device. Such implementations may also reduce the number of selections required to perform a functional operation associated with using a computer device, as the nested menus described herein enable such operations to be performed on a single computer device application rather than a plurality of applications. Such advantages may spare users from having to traverse complicated and non-contextual menus of conventional computer devices.

The inventive concepts disclosed herein have been presented by way of example to illustrate the myriad features thereof in a plurality of illustrative scenarios, embodiments, and/or implementations. It should be appreciated that the concepts generally disclosed are to be considered as modular, and may be implemented in any combination, permutation, or synthesis thereof. In addition, any modification, alteration, or equivalent of the presently disclosed features, functions, and concepts that would be appreciated by a person having ordinary skill in the art upon reading the instant descriptions should also be considered within the scope of this disclosure. While various embodiments have been described above, it should be understood that they have been presented by way of example only, and not limitation. Thus, the breadth and scope of an embodiment of the present invention should not be limited by any of the above-described exemplary embodiments, but should be defined only in accordance with the following claims and their equivalents.

What is claimed is:

1. A method, comprising:
outputting a first menu;
receiving selection of an item from the first menu;
outputting the selected item from the first menu along with a second menu having items corresponding to the selected item of the first menu; and
deemphasizing unselected items from each menu in response to receiving the selection of the item from the respective menu.

2. The method as recited in claim 1, comprising receiving selection of an item from the second menu, and outputting the selected item from the second menu along with a third menu having items corresponding to the selected item of the second menu.

3. The method as recited in claim 1, comprising outputting representations of a plurality of objects, receiving selection of at least one of the representations, and outputting the first menu in response to receiving the selection, wherein the representations of the plurality of objects remain displayed during the outputting of the menus.

4. The method as recited in claim 1, comprising receiving selection of an item from the second menu, wherein each of the selected items remains displayed after each respective outputting operation.

5. The method as recited in claim 4, comprising outputting a trace of the selected items.

6. The method as recited in claim 5, wherein the trace includes an indicator indicative of an order in which selection of the menu items has been received.

7. The method as recited in claim 4, comprising receiving selection of one of the previously-selected items of the first menu, and re-emphasizing the unselected items of the second menu.

8. The method as recited in claim 1, wherein menu items having a nested menu thereunder have a graphical element denoting said nested menu.

9. The method as recited in claim 1, comprising receiving indication of a sensory input, wherein a first action is performed upon receiving a selection, corresponding to a first type of sensory input, of at least one of the menu items,
wherein a second action is performed upon receiving a selection, corresponding to a second type of sensory input, of the at least one of the menu items.

10. A computer program product, comprising: a computer readable storage medium having stored thereon computer readable program instructions configured to cause a processor of a computer system to:
output a first menu;
receive selection of an item from the first menu;
output the selected item from the first menu along with a second menu having items corresponding to the selected item of the first menu; and
deemphasize unselected items from each menu in response to receiving the selection of the item from the respective menu.

11. The computer program product as recited in claim 10, comprising computer readable program instructions for receiving selection of an item from the second menu, wherein the selected item from the second menu is output along with a third menu having items corresponding to the selected item of the second menu.

12. The computer program product as recited in claim 10, comprising computer readable program instructions for outputting representations of a plurality of objects, receiving selection of at least one of the representations, and outputting the first menu in response to receiving the selection, wherein the representations of the plurality of objects remain displayed during the outputting of the menus.

13. The computer program product as recited in claim 10, comprising receiving selection of an item from the second menu, wherein each of the selected items remains displayed after each respective outputting operation.

14. The computer program product as recited in claim 13, comprising computer readable program instructions configured to cause the processor of the computer system to: output a trace of the selected items.

15. The computer program product as recited in claim 14, wherein the trace includes an indicator indicative of an order in which selection of the menu items has been received.

16. The computer program product as recited in claim 13, comprising computer readable program instructions configured to cause the processor of the computer system to: receive selection of the previously-selected items of the first menu, and re-emphasize the unselected items of the second menu.

17. The computer program product as recited in claim 10, wherein menu items having a nested menu thereunder have a graphical element denoting said nested menu.

18. The computer program product as recited in claim 10, comprising computer readable program instructions configured to cause the processor of the computer system to:
receive indication of a sensory input,
wherein a first action is performed upon receiving a selection, corresponding to a first type of sensory input, of at least one of the menu items,
wherein a second action is performed upon receiving a selection, corresponding to a second type of sensory input, of the at least one of the menu items.

19. A system, comprising:
a display, wherein the display includes a sensory input system for receiving selections;
a processor; and
logic integrated with and/or executable by the processor, the logic being configured to cause the processor to:
output a first menu to the display;
receive selection of an item from the first menu;
output the selected item from the first menu along with a second menu having items corresponding to the selected item of the first menu; and
deemphasize unselected items from each menu in response to receiving the selection of the item from the respective menu.

20. The system as recited in claim 19, comprising receiving selection of an item from the second menu, and outputting the selected item from the second menu along with a third menu having items corresponding to the selected item of the second menu.
